(19) United States
(12) Patent Application Publication
(10) Pub. No.: US 2023/0127283 A1
(43) Pub. Date: Apr. 27, 2023

(54) INFORMATION PROCESSING APPARATUS AND INFORMATION PROCESSING METHOD

(71) Applicant: TOYOTA JIDOSHA KABUSHIKI KAISHA, Toyota-shi (JP)

(72) Inventors: Yukinori II, Toyota-shi (JP); Kenji YAMAGUCHI, Miyoshi-shi (JP); Junya OGAWA, Okazaki-shi (JP); Yuki NAGANUMA, Nagoya-shi (JP); Junya YAMAMOTO, Seto-shi (JP); Yuta TONE, Nagoya-shi (JP); Naoki ISHIZUKA, Nagoya-shi (JP); Tadayuki TANAKA, Nagoya-shi (JP); Keisuke ITO, Okazaki-shi (JP); Yuka YOKOI, Miyoshi-shi (JP); Takashi HAYASHI, Nagoya-shi (JP); Naoya OKA, Nagakute-shi (JP); Yu HAMADA, Nagoya-shi (JP)

(73) Assignee: TOYOTA JIDOSHA KABUSHIKI KAISHA, Toyota-shi (JP)

(21) Appl. No.: 17/952,618

(22) Filed: Sep. 26, 2022

(30) Foreign Application Priority Data
Oct. 26, 2021 (JP) 2021-174944

(51) Int. Cl. G06Q 30/02; G06Q 10/00; B05D 5/00; B05D 7/14

(52) U.S. Cl. CPC G06Q 30/0284; G06Q 10/20; B05D 5/005; B05D 7/14; B05D 2350/30

(57) ABSTRACT

The present disclosure properly calculates a wage for coating of a vehicle. An information processing apparatus of the present disclosure accepts specification of a first vehicle on which a third coating film is to be newly formed after a second coating film formed on a first coating film is peeled from a vehicle body. The information processing apparatus calculates a wage for operation of forming the third coating film for the first vehicle based on a period elapsed since peeling of the second coating film.

### CROSS-REFERENCE TO THE RELATED APPLICATION

This application claims the benefit of Japanese Patent Application No. 2021-174944, filed on Oct. 26, 2021, which is hereby incorporated by reference herein in its entirety.

### BACKGROUND

### Technical Field

The present disclosure relates to coating of a vehicle.

### Description of the Related Art

There is a technology for giving appropriate incentive according to the maintenance condition of a vehicle. For example, Japanese Patent Laid-Open No. 2018-060247 discloses a system for discounting an insurance premium according to the maintenance condition and deterioration condition of a vehicle.

[Patent Literature 1] Japanese Patent Laid-Open No. 2018-060247

### SUMMARY

One or more aspects of the present disclosure are directed to properly calculate a wage for coating of a vehicle.

A first aspect of the present disclosure may be an information processing apparatus comprising a controller including at least one processor, the controller being configured to execute accepting specification of a first vehicle on which a third coating film is to be newly formed after a second coating film formed on a first coating film is peeled from a vehicle body, and calculating a wage for operation of forming the third coating film for the first vehicle based on a period elapsed since peeling of the second coating film.

A second aspect of the present disclosure may be an information processing method comprising accepting specification of a first vehicle on which a third coating film is to be newly formed after a second coating film formed on a first coating film is peeled from a vehicle body, and calculating a wage for operation of forming the third coating film for the first vehicle based on a period elapsed since peeling of the second coating film.

Further, another aspect of the present disclosure may be a computer-readable storage medium non-transitorily storing a program for causing a computer to execute the information processing method described above.

According to the present disclosure, it is possible to properly calculate a wage for coating of a vehicle.

### BRIEF DESCRIPTION OF THE DRAWINGS

FIG. 1 is a diagram explaining an outline of a vehicle management system;

FIG. 2 is a diagram explaining configurations of a management server and a base server;

FIG. 3 illustrates an example of data stored in a coating database;

FIG. 4A illustrates an example of operation data generated by the base server;

FIG. 4B illustrates an example of operation data generated by the base server;

FIG. 5A illustrates an example of a table that stores wages for coating;

FIG. 5B illustrates an example of a table that stores wages for coating;

FIG. 6A is a schematic diagram of coating by easy-to-peel paint;

FIG. 6B is a schematic diagram of coating by easy-to-peel paint;

FIG. 7 is a flowchart of a process executed by the base server;

FIG. 8 illustrates an example of a screen provided by the base server;

FIG. 9A illustrates an example of a screen provided by the base server;

FIG. 9B illustrates an example of a screen provided by the base server;

FIG. 10 is a flowchart of a process executed by the management server;

FIG. 11 is a sequence diagram of a process for determining a wage for coating;

FIG. 12 is a flowchart of a process executed at step S33;

FIG. 13 is a diagram illustrating the relationship between vehicle conditions and necessary processes;

FIG. 14 is a diagram explaining an area that requires cleaning;

FIG. 15 is a diagram exemplifying the relationship between the number of days elapsed and operation performed in a cleaning process; and

FIG. 16 is a diagram exemplifying the relationship between the number of days elapsed and a cleaning wage.

### DESCRIPTION OF THE EMBODIMENTS

There is a technology of applying coating to the body of a vehicle using a peelable coating film. Since such a coating film can be peeled later, it is possible to change the body color at an arbitrary timing. Thereby, it becomes possible to select a body color that is popular in the market at the time of purchasing a vehicle, overpaint the vehicle with the purchaser's favorite color to use the vehicle and return the color to the original color at the time of selling the vehicle. Further, since an original coating film is protected by the overpainted coating, the value of a used automobile can be enhanced in comparison with the case of not applying overpainted coating.

Note that, in this specification, “overpainting (of coating)” refers to forming a peelable coating film at least on a part of a vehicle. Further, “peeling (of coating)” refers to removing the overpainted coating film.

An amount of operation at the time of forming a peelable coating film depends on the condition of coating that is to be the base. For example, immediately after a new automobile is manufactured, overpainted coating can be immediately performed. However, in a case where a vehicle has been placed for a long time with the coating, which is to be the base, exposed, there are fine scratches on the coating film. Therefore, a process of cleaning the base or a process of removing the scratches is required before coating is performed. That is, a process required when overpainted coating is performed for a vehicle differs according to the vehicle.

Therefore, when wages required for coating are uniform, inconvenience occurs.

An information processing apparatus according to the present disclosure solves such a problem.

An information processing apparatus according to a first aspect of the present disclosure may comprise a controller including at least one processor, the controller being configured to execute accepting specification of a first vehicle on which a third coating film is to be newly formed after a second coating film formed on a first coating film is peeled from a vehicle body, and calculating a wage for operation of forming the third coating film for the first vehicle based on a period elapsed since peeling of the second coating film.

The first coating film may be a coating film that the vehicle originally includes. The second and third coating films may be later peelable coating films. The peelable coating film may be, for example, a combination of a peelable film and a normal coating film or may be a colored coating film that is peelable itself (a coating film of easy-to-peel paint). By forming a peelable coating film on a coating film that a vehicle originally includes, it becomes possible to easily change the body color.

When the third coating film is to be newly formed after the second coating film is peeled from the vehicle body, the controller may determine a wage therefor based on time elapsed since the timing of peeling the second coating film. For example, when the third coating film is applied immediately after the second coating film is peeled, the cleaning process may be omitted because the surface condition of the base (the first coating film) is kept favorable. In such a case, the wage can be kept low. On the other hand, when a certain amount of time has elapsed since peeling of the second coating film, an additional process can be required because the base has deteriorated. In such a case, an additional wage is required. Thus, the information processing apparatus according to the embodiment can appropriately determine a wage required for overpainted coating.

Specific embodiments of the present disclosure will be described below based on drawings. Hardware configuration, module configuration, functional configuration and the like described in each embodiment are not intended to limit the technological scope of the disclosure only to the components unless otherwise stated.

### First Embodiment

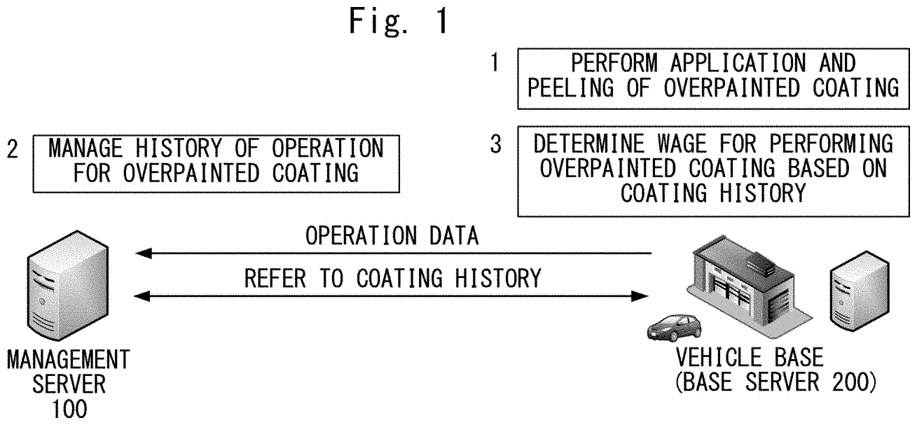

An outline of a vehicle management system according to a first embodiment will be described with reference to FIG. 1.

The vehicle management system according to the present embodiment is configured including a management server 100 that manages information about a plurality of vehicles, and a base server 200 corresponding to a vehicle base.

The management server 100 is an apparatus that manages information about vehicles manufactured by automobile manufacturers and provided for users. For the management target vehicles, coating operation can be performed at a predetermined vehicle base. The coating operation includes, for example, (1) operation of forming a coating film at the time of manufacturing a new automobile, (2) operation of forming a peelable coating film on an original coating film, (3) operation of peeling the coating film, and the like. By forming the coating film on the original coating film at a vehicle base, the body color of a vehicle can be changed. Further, by peeling the coating film, the body color of the vehicle can be returned to the original color.

Further, the management server 100 includes a database for recording histories of coating operation performed in the past (hereinafter, coating histories) for the plurality of vehicles under its management.

The base server 200 is a server apparatus associated with a vehicle base where coating operation is performed for a vehicle. The vehicle base is, for example, a vehicle manufacturing factory, a maintenance shop, a car dealer or the like. When coating operation is performed for a vehicle, the base server 200 generates data indicating details of the coating operation (hereinafter, operation data) and transmits the operation data to the management server 100. Thereby, the database is updated.

Further, the base server 200 determines an operation wage for applying a peelable coating film on a predetermined vehicle, based on a coating history of the vehicle acquired from the management server 100. A specific method will be described later.

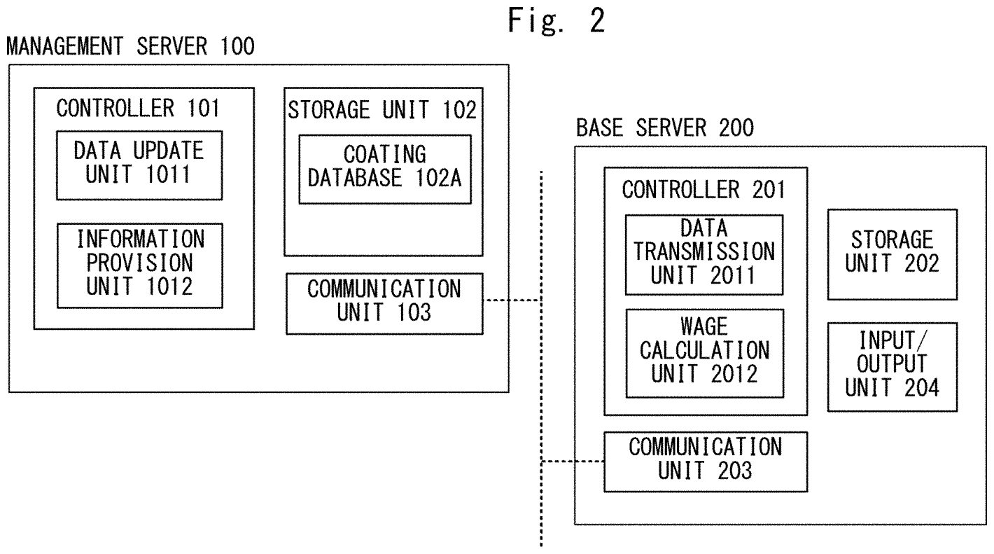

FIG. 2 is a diagram illustrating components of the management server 100 and the base server 200 that are included in the vehicle management system according to the present embodiment in more detail.

First, the management server 100 will be described.

The management server 100 stores the database that manages coating histories for the plurality of vehicles under its management (hereinafter, the coating database). Further, the management server 100 updates the coating database based on operation data received from the base server 200.

In response to an inquiry from the base server 200, the management server 100 acquires detailed information about a predetermined vehicle from these databases and provides the information.

The management server 100 can be configured with a general-purpose computer. That is, the management server 100 can be configured as a computer that includes a processor such as a CPU or a GPU, a main memory such as a RAM and a ROM, an auxiliary storage device such as an EPROM, a hard disk drive or a removable medium. In the auxiliary storage device, an operating system (OS), various kinds programs, various kinds of tables and the like are stored. By loading a program stored in the auxiliary storage device onto a work area of the main memory to execute the program, and each of the components and the like being controlled through the execution of the program, each function corresponding to a predetermined purpose as described later can be realized. However, a part or all of the functions may be realized by a hardware circuit such as an ASIC or an FPGA.

The management server 100 is configured including a controller 101, a storage unit 102 and a communication unit 103.

The controller 101 is an arithmetic device in charge of control performed by the management server 100. The controller 101 can be realized by an arithmetic processing device such as a CPU.

The controller 101 is configured including two functional modules of a data update unit 1011 and an information provision unit 1012. Each functional module may be realized by executing a stored program by the CPU.

The data update unit 1011 updates the database that stores coating histories of vehicles (the coating database) based on data received from the base server 200 (operation data). When receiving the operation data from a base server 200 (that is, when coating operation has been performed for a given vehicle), the data update unit 1011 adds a record corresponding to the content of the operation data to the coating database.

When a vehicle is newly manufactured, the vehicle includes an original body color. When coating operation is performed for the vehicle, overpainting of coating is performed, and the body color changes. Further, when the overpainted coating is peeled, the body color also changes.

The coating database is a database that holds all histories of coating operation from the time of manufacturing a new automobile. Since the coating database is updated by the data update unit 1011 as necessary, a third person can obtain information about what condition the coating of a given vehicle is in, by referring to the coating database. Details of the coating database will be described later.

The information provision unit 1012 acquires information about a specified vehicle based on the coating database described above and provides the information for the base server 200. For the specified vehicle, the information provision unit 1012 provides, for example, a coating condition (whether overpainted coating is applied or not), a date when the overpainted coating was applied, a date when the overpainted coating was peeled, and the like.

The storage unit 102 is configured including a main memory and an auxiliary storage device. The main memory is a memory where programs executed by the controller 101 and data used by the control programs are developed. The auxiliary storage device is a device in which the programs executed by the controller 101 and the data used by the control programs are stored.

Further, the storage unit 102 stores a coating database 102A described above.

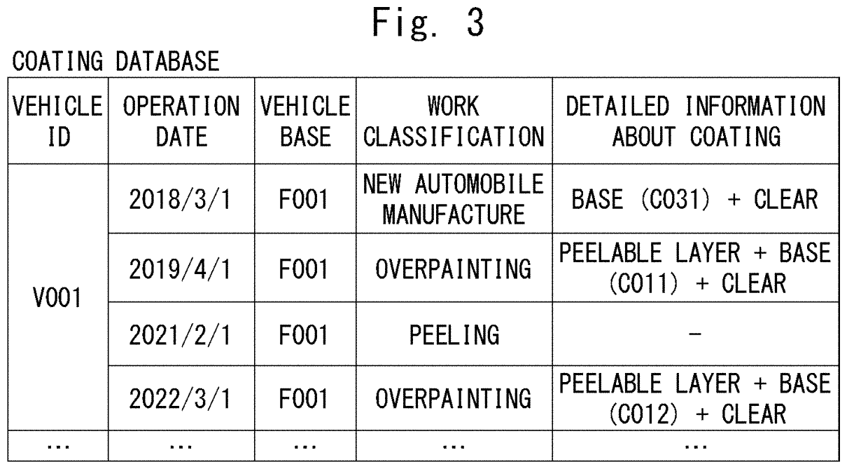

The coating database 102A is a database that stores histories of coating operation performed for particular vehicles. FIG. 3 illustrates an example of data stored in the coating database 102A.

In the present embodiment, coating operation is any of (1) coating operation at the time of manufacturing a new automobile, (2) operation of overpainting peelable paint and (3) operation of peeling peelable paint. In the example of FIG. 3, one record corresponds to one time of coating operation. When operation data is received from a base server 200 (that is, coating operation has been performed for a certain vehicle), a record corresponding to the coating operation is newly added.

The coating database 102A includes, for each vehicle, an identifier, the dates when coating operation was performed, vehicle bases where coating operation was performed, work classifications (coating operation classification; that is, any of (1) to (3) described above), detailed information about coating and the like. The detailed information about coating is, for example, information indicating what coating was applied for which layer.

Each piece of data described above may be constructed by a database management system (DBMS) program, which is executed by the processor, managing data stored in the storage device. In this case, each piece of data may be, for example, a relational database.

The communication unit 103 is a communication interface for connecting the management server 100 to a network. The communication unit 103 is configured, for example, including a network interface board and a wireless communication interface for wireless communication.

Next, the base server 200 will be described.

The base server 200 is a computer installed at a base where coating operation for a vehicle is performed and, when coating operation is performed for a vehicle, transmits data about the content of the coating operation (operation data) to the management server 100.

The coating operation is performed, for example, when there is an order for coating by a user. Further, when a target vehicle is a leased vehicle, there may be a case where coating is peeled to return the body color to an original body color at the time of returning the vehicle. Furthermore, there may be a case where coating of a vehicle purchased as a used automobile is peeled in response to a business operator's instruction. Note that a base server 200 may be installed at a base where vehicles are manufactured (a manufacturing base).

Similarly to the management server 100, the base server 200 can be configured with a computer. That is, the base server 200 can be configured as a computer that includes a processor such as a CPU or a GPU, a main memory such as a RAM and a ROM, an auxiliary storage device such as an EPROM, a hard disk drive or a removable medium.

The base server 200 is configured including a controller 201, a storage unit 202, a communication unit 203 and an input/output unit 204.

The controller 201 is an arithmetic device in charge of control performed by the base server 200. The controller 201 can be realized by an arithmetic processing device such as a CPU.

The controller 201 is configured including two functional modules of a data transmission unit 2011 and a wage calculation unit 2012. Each of the functional modules may be realized by executing a stored program by the CPU.

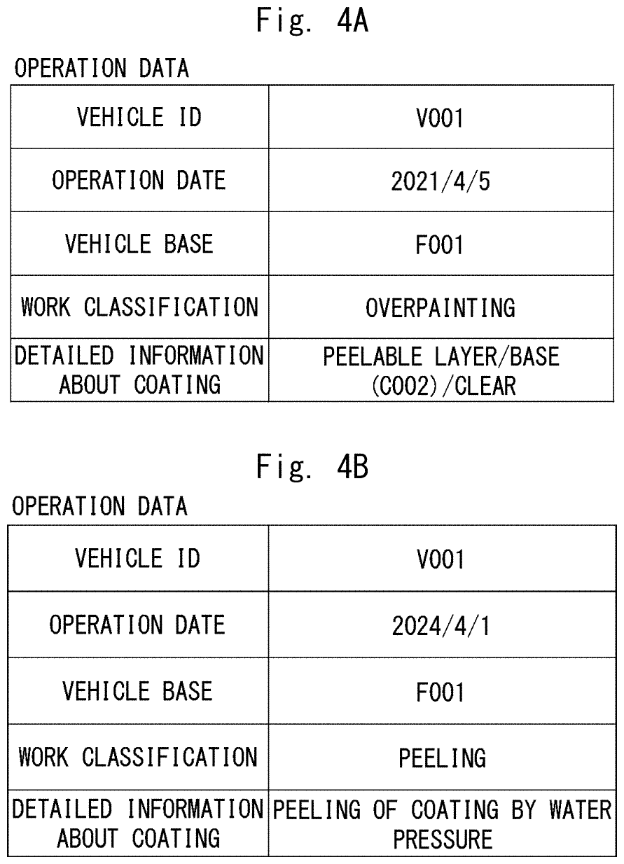

The data transmission unit 2011 generates operation data based on the content of an input operation made by a staff member at the vehicle base and transmits the operation data to the management server 100. FIGS. 4A and 4B illustrates diagrams exemplifying the content of the operation data.

As illustrated, the operation data includes fields for a vehicle identifier, an operation date, a vehicle base, a work classification, and detailed information about coating.

The vehicle identifier is an identifier that uniquely identifies a target vehicle (for example, a chassis number, a VIN (vehicle identification number) or the like). The operation date is a date when the coating operation was performed, and the “vehicle base” indicates an identifier that uniquely identifies a vehicle base where the coating operation was performed. For the work classification, any of “coating at the time of manufacturing a new automobile”, “overpainting (of coating)” and “peeling (of overpainted coating)” is stored.

The “detailed information about coating” is a field where information about details of coating is stored.

Specifically, characteristics of paint (whether peelable or not), information about color (a color number or the like), whether layered coating is applied or not, order of layered coatings, whether there is an additional layer (such as a clear layer) and the like are stored.

FIG. 4A illustrates an example of operation data generated when overpainting of coating is performed. FIG. 4B illustrates an example of operation data generated when peeling of overpainted coating is performed. The operation data is generated by the data transmission unit 2011 based on information inputted via the input/output unit 204 described later.

Note that, when the base server 200 is an apparatus corresponding to a manufacturing base of a vehicle, the base server 200 may generate operation data to the effect that coating is performed when newly manufacturing the vehicle. In this case, the work classification is “coating at the time of manufacturing a new automobile”.

The operation data generated by the data transmission unit 2011 is transmitted to the management server 100.

The wage calculation unit 2012 calculates a wage for overpainting peelable coating on a vehicle.

As described above, the number of processes at the time of overpainting peelable coating can change according to the condition of a vehicle. Here, the following three patterns will be exemplified. The wage calculation unit 2012 determines a wage for overpainting coating on a given vehicle according to the patterns.

(Pattern 1) The case of peeling existing coating and then immediately performing overpainting of coating

In the case of peeling existing coating and then immediately performing overpainting of coating, the overpainting of coating can be started without performing the cleaning process because the condition of the base remains favorable.

(Pattern 2) The case of performing overpainting of coating in a short period after peeling existing coating

The short period refers to such a period that the base coating does not deteriorate. In this case, overpainting of coating can be started without performing cleaning, similarly to the pattern 1, or after performing cleaning omitting a part of the process.

(Pattern 3) The case of peeling existing coating and performing overpainting of coating after a certain period time elapses

When a certain period of time elapses after existing coating is peeled, the cleaning process is required because the base coating deteriorates. The cleaning process includes, for example, operation of washing the surface of a coating film, operation of polishing the surface of the coating film, operation of removing scratches made on the surface of the coating film, and the like. In this case, wages corresponding to these kinds of operation are additionally required.

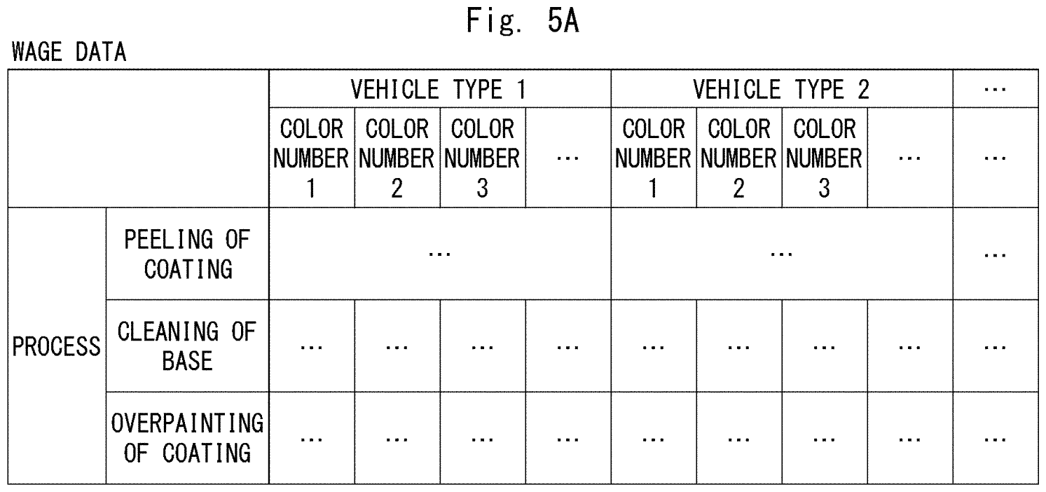

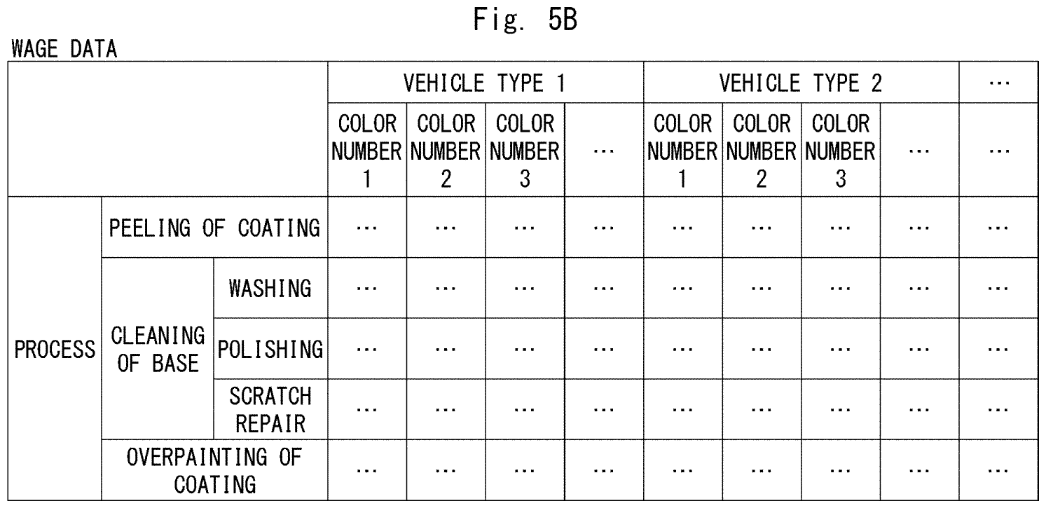

The wage calculation unit 2012 may store a basic wage for each of a plurality of processes such as the cleaning process and the coating process to use the basic wage for the calculation. The basic wage may fluctuate according to the area to be painted, the area to be cleaned and the like. The basic wage may be stored, for example, as a unit price per unit area (for example, per square centimeters). Further, the basic wage may be defined for each vehicle type. FIG. 5A illustrates an example of a table that defines basic wages (wage data). Such data may be stored in the storage unit 202 in advance.

In the example in FIG. 5A, a unit wage for each of a process of performing peeling of coating, a process of performing cleaning and a process of performing overpainting of coating is defined for each vehicle type and for each coating color.

The storage unit 202 is configured including a main memory and an auxiliary storage device. The main memory is a memory where programs executed by the controller 201 and data used by the control programs are developed. The auxiliary storage device is a device in which the programs executed by the controller 201 and the data used by the control programs (including operation data) are stored.

The communication unit 203 is a communication interface for connecting the base server 200 to a network. The communication unit 203 is configured, for example, including a network interface board and a wireless communication interface for wireless communication.

The input/output unit 204 is a unit that accepts an input operation performed by a user and presents information to the user. The input/output unit 204 may include, for example, an interface with an external display, a keyboard, a mouse and the like.

Note that the configuration illustrated in FIG. 2 is an example, and all or a part of the illustrated functions may be executed using a circuit designed for dedicated use. Further, storage or execution of a program may be performed by a combination of a main memory and an auxiliary storage device other than those that are illustrated.

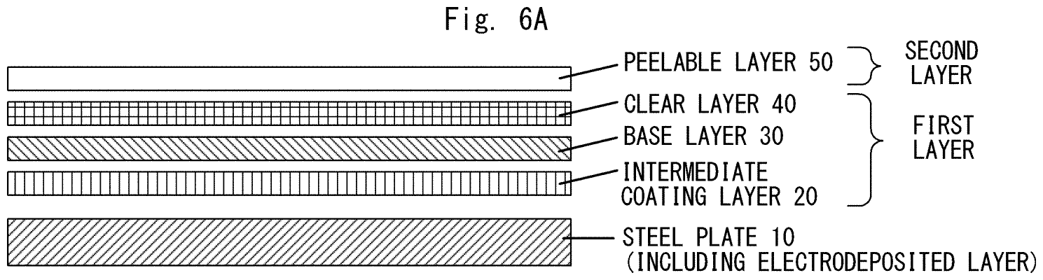

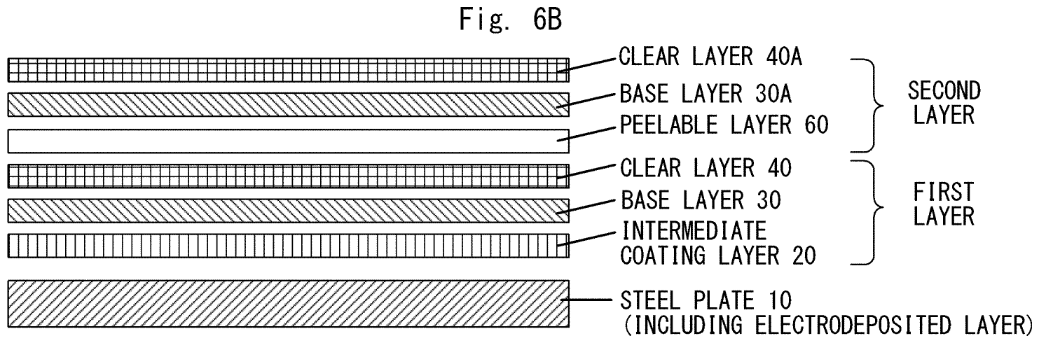

Here, a peelable coating film will be simply described. FIG. 6A is a schematic sectional view illustrating a body member (for example, a steel plate) that a vehicle body includes and coating films applied on the body member. As illustrated, the body member includes a steel plate 10 which is metal worked and on which an electrodeposited layer is formed, and an intermediate coating layer 20, a base layer 30 and a clear layer 40 that are formed sequentially on the electrodeposited layer.

These layers correspond to coating in the first layer (original coating, that is, a first coating film).

A peelable layer 50 is formed on the outer surface of the body member as the second layer. The peelable layer 50 is a layer of easy-to-peel paint, which includes a property of being easily peeled by force being applied in comparison with a normal coating film. The peelable layer 50 is formed by applying easy-to-peel paint to the body member, for example, by a spraying method. As the easy-to-peel paint, paint made of xylene, ethylbenzene, an antioxidant, methyl ethyl ketone, silica reactant, titanium oxide (nanoparticles), an organic solvent and the others is exemplified.

Overpainted coating of a vehicle with easy-to-peel paint can be performed at a predetermined vehicle base. Thereby, it is possible to easily change the body color of a vehicle (that is, change the body color from a first body color to a second body color). The same goes for peeling of the peelable layer 50. By peeling the peelable layer 50 at a predetermined vehicle base, the body color of a vehicle can be returned to an original color (that is, returned from the second body color to the first body color).

Note that, though a steel plate is exemplified as the body member in this example, the body member may be a resin member. In this case, the intermediate coating layer 20 is a primer layer. A clear layer may be further provided on the peelable layer 50.

Note that, though the easy-to-peel property is given to the paint itself in the example of FIG. 6A, normal coating may be applied on a layer including the easy-to-peel property. For example, as illustrated in FIG. 6B, a peelable layer 60 that is not colored may be formed with material similar to that of the peelable layer 50, and a base layer 30A and a clear layer 40A may be formed on the peelable layer 60. The base layer 30A is a paint layer including a color different from the base layer 30. In such a form, it is also possible to remove the paint layers by peeling the peelable layer 60.

Note that, though single color is exemplified as each of a body color and a color of overpainted coating in this example, coating with a plurality of colors may be applied. For example, a plurality of colors arranged in a predetermined pattern may be a body color. Further, “color” in this specification may be such that is expressed not only by a single layer but by a plurality of layers of paint or material. The plurality of layers may include, for example, a clear layer, a glass flake layer, a mica layer, a pearl layer and the like.

Further, overpainted coating may be applied at least to a part of original coating. That is, overpainted coating does not have to cover all the original coating. For example, when an original body color is black, it is possible to, by overpainting blue on a part of the body, obtain a vehicle including two-tone color of black and blue.

Next, details of a process executed by apparatuses included in the vehicle management system will be described.

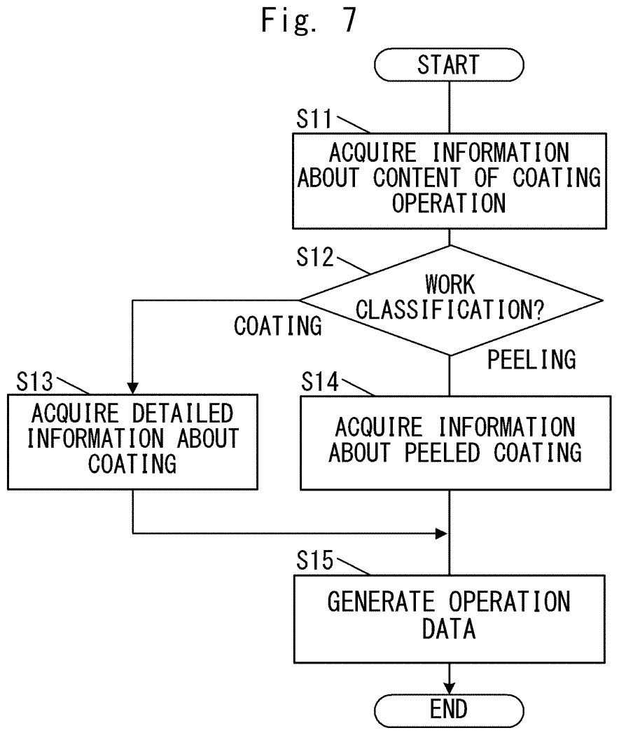

FIG. 7 is a flowchart illustrating a process executed by the base server 200 (the controller 201). The process illustrated in FIG. 7 is executed when coating operation is applied to a vehicle at a predetermined vehicle base.

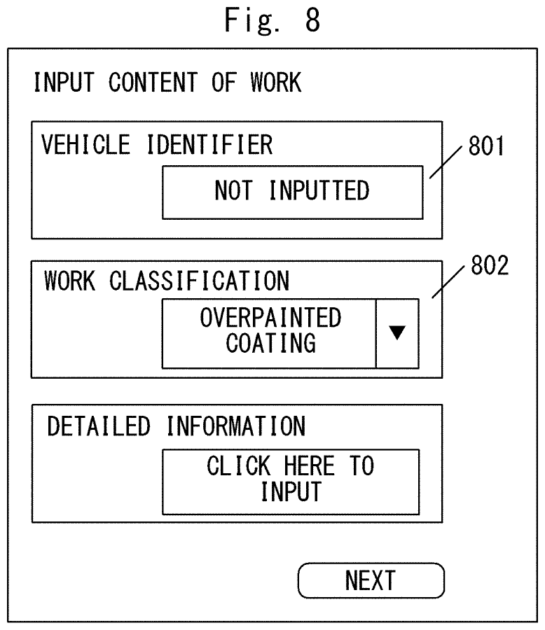

First, at step S11, information about the content of coating operation is acquired. At this step, for example, a vehicle identifier and a work classification are acquired. In this example, the work classification is any of “coating at the time of manufacturing a new automobile”, “overpainting (of coating)” and “peeling (of overpainted coating)”. The information may be inputted, for example, via a screen as illustrated in FIG. 8. In the example of FIG. 8, reference sign 801 indicates a GUI part for causing a vehicle identifier to be inputted. Reference sign 802 indicates a GUI part for causing a work classification to be selected.

At step S12, the work classification is judged. When the work classification is coating at the time of manufacturing a new automobile or overpainted coating, the process transitions to step S13.

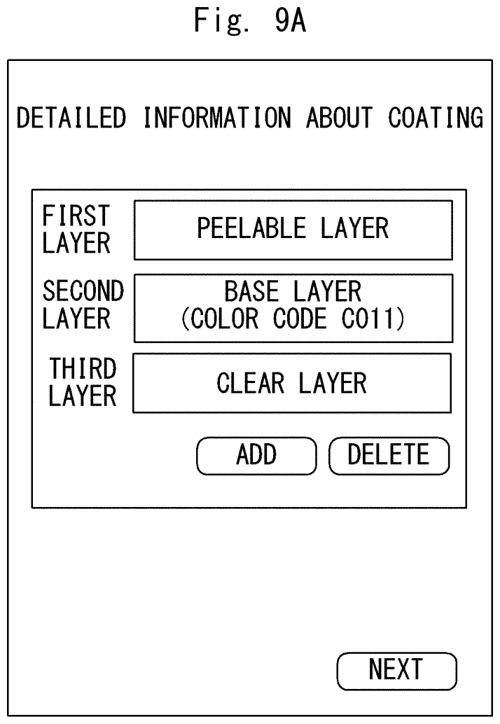

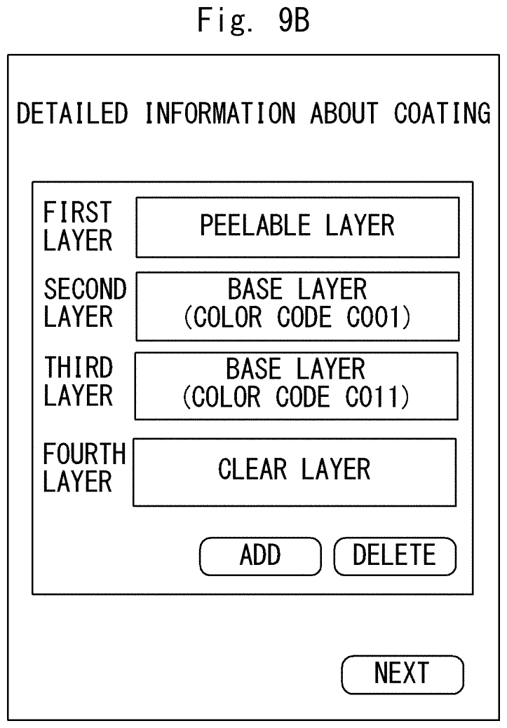

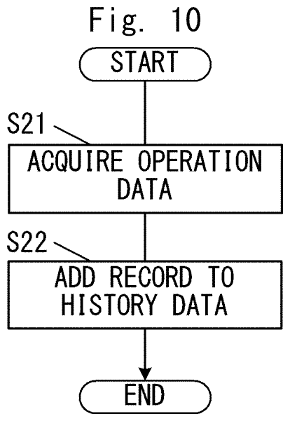

At step S13, detailed information about the coating is acquired. At this step, for example, the number of layers formed at the time of applying the coating, detailed information about paint corresponding to each layer and the like are acquired. These pieces of information may be inputted, for example, via a screen as illustrated in FIGS. 9A and 9B. For example, FIG. 9A illustrates an input example in a case where after providing a transparent peelable layer, a base layer is provided, and then, a clear layer is provided. FIG. 9B illustrates an input example in a case where after providing a peelable layer, base layers respectively including different two kinds of colors are provided, and then, a clear layer is provided. Thus, it is also possible to input detailed information for each layer.

When the work classification is peeling of coating, the process transitions to step S14.

At step S14, information about peeling of the coating is acquired. At this step, for example, information to the effect that the top layer was removed by a predetermined means. The predetermined means is, for example, a means by a high-pressure water flow, manual operation or the like. The information about peeling of the coating may include the name of equipment used for peeling, a set value for a water pressure or the like.

At step S15, the base server 200 (the data transmission unit 2011) generates operation data based on the information described above. Thereby, the operation data as illustrated in FIGS. 4A and 4B is generated. The generated operation data is transmitted to the management server 100 and processed by the data update unit 1011.

FIG. 10 is a flowchart of a database update process performed by the management server 100 (the data update unit 1011).

First, at step S21, operation data transmitted from the base server 200 is acquired.

Next, at step S22, a record corresponding to coating operation performed for a target vehicle is added to the coating database 102A. That is, a record that includes a vehicle identifier, an operation date, a work base, a work classification, and detailed information about coating is newly added. Note that, at the timing of database update being completed, the base server 200 may be notified thereof.

By the process described above, update of the coating database 102A that the management server 100 includes is performed.

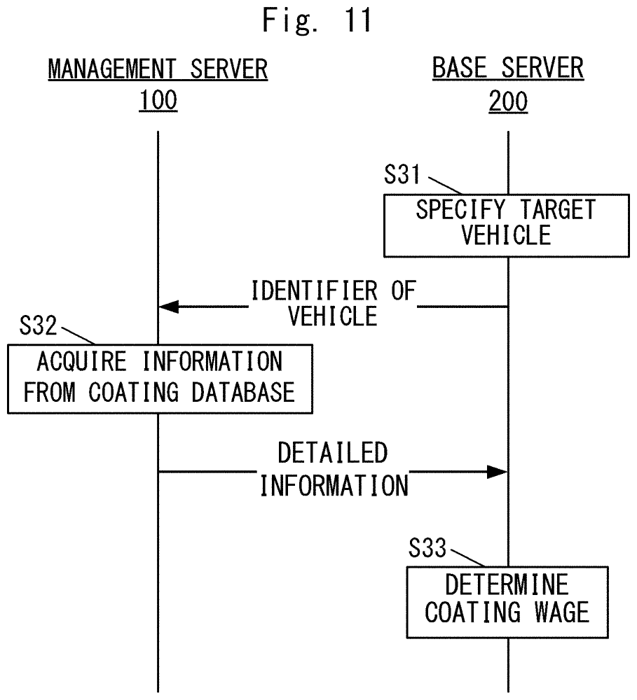

Next, a process for the base server 200 to determine a coating wage for a given vehicle will be described. FIG. 11 is a sequence diagram of the process for the base server 200 to determine the coating wage.

First, at step S31, the base server 200 specifies a target vehicle. At this step, for example, a staff member in charge of coating operation inputs an identifier for uniquely identifying the target vehicle (for example, a VIN or a chassis number). The identifier is transmitted to the management server 100.

Next, at step S32, the management server 100 acquires data corresponding to the specified vehicle from the coating database 102A. The acquired data is transmitted to the base server 200.

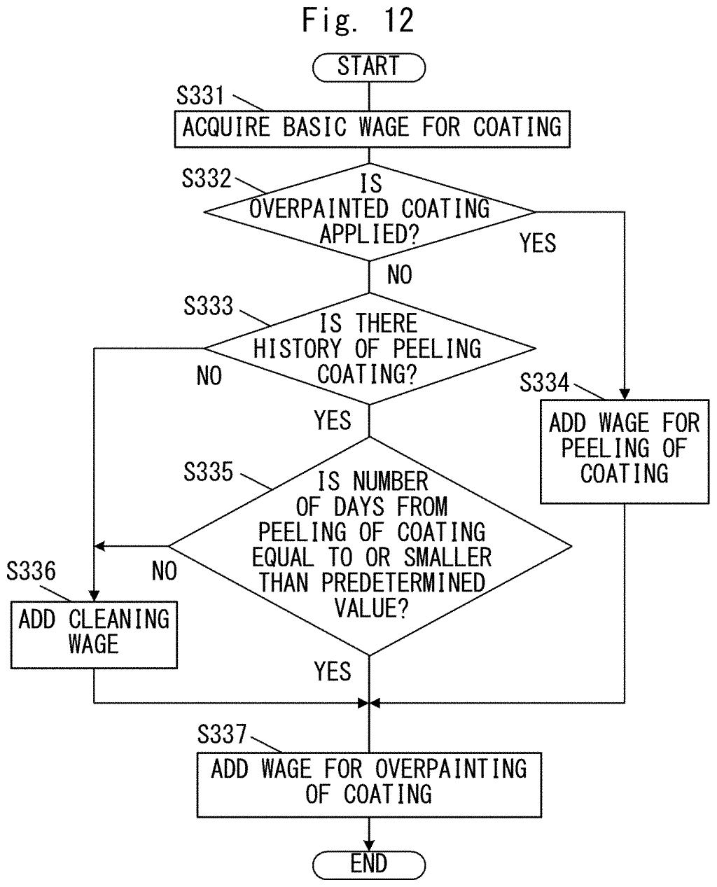

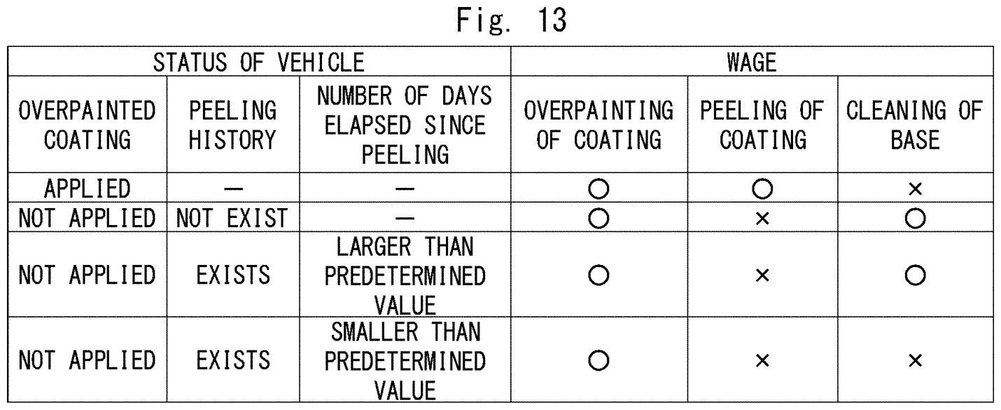

At step S33, the base server 200 (the wage calculation unit 2012) determines a coating wage corresponding to the target vehicle. FIG. 12 is a flowchart illustrating details of the process at step S33.

First, at step S331, a basic wage for coating is acquired. At this step, for example, a set of wages corresponding to vehicle types (and coating colors) is acquired for the plurality of processes based on the wage data as illustrated in FIG. 5A.

Next, at step S332, it is judged whether overpainted coating is applied to the target vehicle or not. When overpainted coating is applied to the target vehicle, that is, when the process of peeling the coating is required before overpainted coating is newly performed, the process transitions to step S334. When overpainted coating is not applied to the target vehicle, the process transitions to step S333.

At step S333, it is judged whether or not there is a history of peeling overpainted coating for the target vehicle. The judgment can be made based on the data acquired from the coating database 102A. When there is the history of peeling overpainted coating for the target vehicle in the past, the process transitions to step S335. When there is no history of peeling overpainted coating for the target vehicle, the process transitions to step S336.

At step S335, it is judged whether or not the number of days elapsed since overpainted coating was peeled last is equal to or smaller than a predetermined value. The judgment can be made also based on the data acquired from the coating database 102A. When the number of days from the date when the overpainted coating was peeled last is equal to or smaller than the predetermined value, the process transitions to step S337. Otherwise, the process transitions to step S336.

At step S336, a wage for cleaning the base where coating is to be performed (a cleaning wage) is added. The process transitions to this step in any of the following cases.

The case where overpainted coating is not currently applied and there is no history of peeling overpainted coating.

The case where there is the history of peeling overpainted coating, but the predetermined or larger number of days have elapsed since the peeling.

In such cases, since the coating film to be the base of new coating has been exposed for a long time, a process of cleaning the coating film (for example, operation of repairing fine scratches made on the coating film) is required.

The process transitions to step S334 in the case of applying new coating after peeling the current coating. In such a case, the cleaning process is not required because the condition of the base is kept favorable, but a process of peeling the current coating is required. Therefore, a wage for peeling the current coating is added.

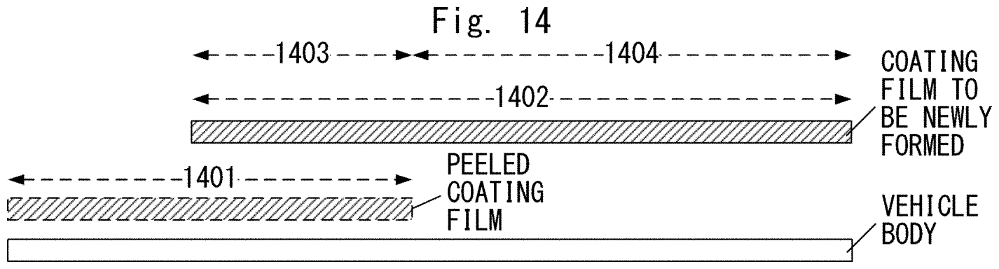

At step S337, a wage for applying new coating is added to obtain a final wage. FIG. 13 illustrates the plurality of cases described above in a table.

As described above, in the vehicle management system according to the first embodiment, the management server 100 stores coating operation histories for the plurality of vehicles under its management and provides coating history information in response to an inquiry from the base server 200.

The base server 200 judges necessary processes based on the coating history information and calculates wages corresponding to the processes. Thereby, it becomes possible to appropriately calculate a wage required for overpainted coating.

Note that, in the first embodiment, the three kinds of wages, the wage required for overpainting of coating, the wage required for peeling of coating and the wage required for cleaning of the base, are defined, as illustrated in FIG. 13, and these wages are added according to necessary processes. However, the final wage may be determined in other methods.

For example, a wage required in the case of executing all the three processes is assumed as the basic wage so that, when there is a process to be omitted, a corresponding wage may be subtracted.

### Second Embodiment

The first embodiment assumes a case where an area where coating is to be peeled and an area where overpainted coating is to be newly applied correspond. However, there may be a case where the area where coating is to be peeled and the area where overpainted coating is to be newly applied do not correspond. For example, it is a case where, after a coating film formed on the whole vehicle body is peeled, a new coating film is formed on a part of the vehicle body (for example, only a roof panel). A second embodiment is an embodiment in which a cleaning wage is determined according to each of the coating areas in order to respond to such a case.

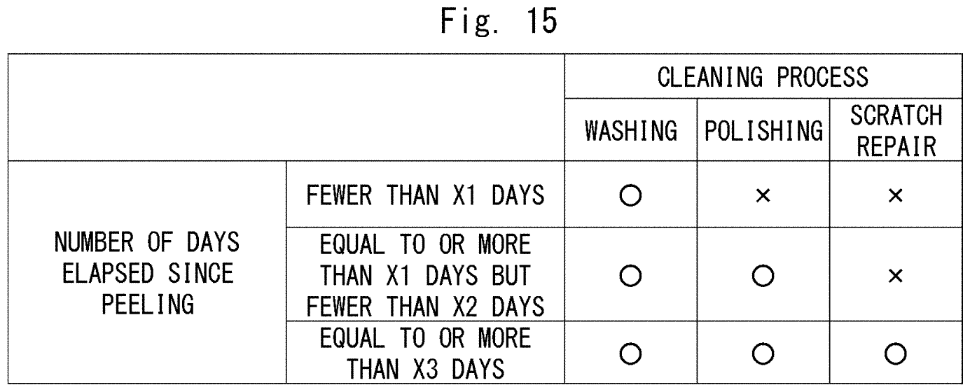

In the second embodiment, a wage for cleaning is determined according to the area of a part that requires cleaning. FIG. 14 is a diagram exemplifying a cross-sectional view of a vehicle body to which coating is to be applied. Here, reference sign 1401 indicates an area where a peelable coating film was formed in the past, and reference sign 1402 indicates an area where a peelable coating film is to be newly formed.

In this example, when the number of days elapsed since an existing coating film was peeled is smaller than a predetermined value, cleaning is not required for the area indicated by reference sign 1403. Therefore, a wage is calculated on the assumption that cleaning is required only for the area indicated by reference sign 1404. In other words, a wage corresponding to cleaning operation is calculated only for a part where the area where the existing coating film was peeled and the area where a coating film is to be newly formed overlap.

On the other hand, when the number of days elapsed since the existing coating film was peeled is larger than the predetermined value, a wage corresponding to cleaning operation is calculated for all the area indicated by reference sign 1402.

When an area where a coating film was applied before and an area where a coating film is to be newly applied are different, it becomes possible to determine a more accurate wage by the process as described above.

### Third Embodiment

In the first embodiment, when the number of days elapsed since an existing overpainted coating was peeled is larger than a predetermined value, it is judged that the cleaning process is required. However, depending on the number of days elapsed since the coating was peeled, it may not be appropriate to make a judgment about whether cleaning is required or not in two stages.

For example, there is a case where only washing of the surface is performed when it is only a short time since existing coating was peeled, and scratches made on the base are removed when a larger number of days have elapsed. Therefore, a wage may be set in stages based on the number of days elapsed since existing coating was peeled.

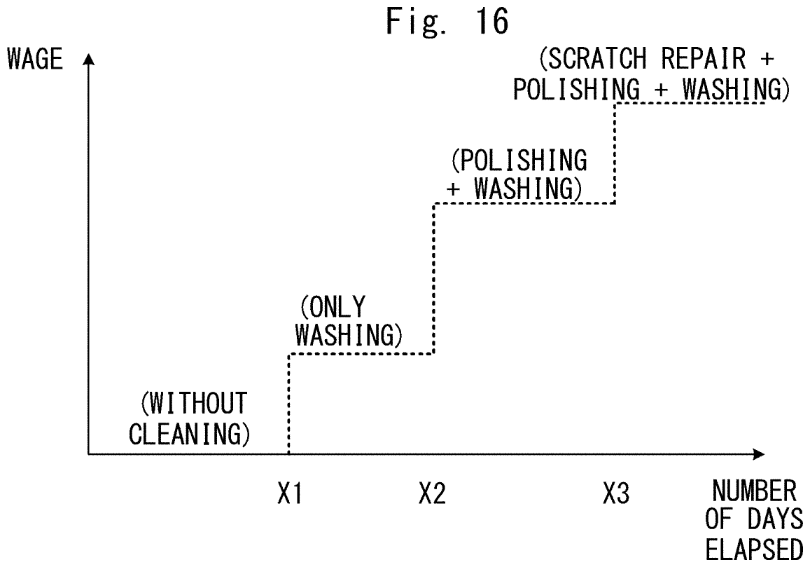

FIG. 15 is a table exemplifying a plurality of kinds of operation required to be performed in the cleaning process according to the number of days elapsed since coating was peeled. In this example, thresholds X₁, X₂ and X₃ (X₁<X₂<X₃) are provided for the number of days elapsed, and each kind of operation of “washing”, “polishing” and “scratch repair” is associated with the thresholds. As illustrated, as the number of days elapsed since coating was peeled increases, the number of required kinds of operation increases.

In the present embodiment, at step S336, the wage calculation unit 2012 judges the kinds of necessary operation based on the number of days elapsed since overpainted coating was peeled. Further, a wage for the cleaning process is calculated based on the judged kinds of operation. FIG. 5B illustrates an example of wage data in a case where the cleaning process includes a plurality of kinds of operation. The data may be stored in the storage unit 102 in advance. FIG. 16 is a diagram exemplifying the relationship between the number of days elapsed and a cleaning wage.

### MODIFICATIONS

The embodiments described above are mere examples, and the present disclosure can be appropriately changed and implemented within a range not departing from the spirit of the disclosure.

For example, the processes and means described in the present disclosure can be freely combined and implemented as far as technical inconsistency does not occur.

In the description of the embodiments, the judgment of the number of days elapsed is made by referring to the database in which the coating history of a target vehicle is recorded. However, the judgment may be made based on any other data as long as a date when overpainted coating was peeled last can be acquired.

Further, a process described as being performed by one apparatus may be shared and executed by a plurality of apparatuses. Or alternatively, processes described as being performed by different apparatuses may be executed by one apparatus. In a computer system, by what hardware configuration (server configuration) each function is realized can be flexibly changed.

The present disclosure can also be realized by supplying a computer program implemented with the functions described in the above embodiments to a computer, and one or more processors that the computer includes reading out and executing the program. Such a computer program may be provided for the computer by a non-transitory computer-readable storage medium that can be connected to the system bus of the computer or may be provided for the computer via a network. As the non-transitory computer-readable storage medium, for example, any type of disk such as a magnetic disk (a floppy (registered trademark) disk, a hard disk drive (HDD) or the like) and an optical disk (a CD-ROM, a DVD disk/a Blu-ray disc or the like), a read-only memory (ROM), a random access memory (RAM), an EPROM, an EEPROM, a magnetic card, a flash memory, an optical card and any type of medium suitable for storing electronic instructions are included.

What is claimed is:

1. An information processing apparatus comprising a controller including at least one processor, the controller being configured to execute:
accepting specification of a first vehicle on which a third coating film is to be newly formed after a second coating film formed on a first coating film is peeled from a vehicle body; and
calculating a wage for operation of forming the third coating film for the first vehicle based on a period elapsed since peeling of the second coating film.

2. The information processing apparatus according to claim 1, wherein the second coating film and the third coating film are later peelable coating films.

3. The information processing apparatus according to claim 2, wherein the controller further acquires, for the first vehicle, data indicating a history of operation for the later peelable coating film.

4. The information processing apparatus according to claim 2, wherein the controller further acquires, for the first vehicle, data indicating a date when the second coating film was peeled.

5. The information processing apparatus according to claim 1, wherein the controller calculates the wage lower in a case where the period elapsed is shorter in comparison with a case where the period elapsed is long.

6. The information processing apparatus according to claim 1, wherein, in a case where the period elapsed is less than a predetermined value, the controller calculates the wage lower than that in a case where the period elapsed is more than the predetermined value.

7. The information processing apparatus according to claim 6, wherein, in the case where the period elapsed is less than the predetermined value, the controller calculates the wage obtained by subtracting an amount of money corresponding to cleaning operation for the vehicle body.

8. The information processing apparatus according to claim 6, wherein, in the case where the period elapsed is less than the predetermined value, the controller calculates the wage obtained by subtracting an amount of money corresponding to cleaning operation for a part where an area where the second coating film is peeled and an area where the third coating film is to be formed overlap.

9. The information processing apparatus according to claim 6, wherein, in the case where the period elapsed is more than the predetermined value, the controller calculates the wage obtained by adding an amount of money corresponding to cleaning operation for the vehicle body.

10. The information processing apparatus according to claim 9, wherein the amount of money to be added is determined based on an application area of the third coating film.

11. An information processing method comprising:
accepting specification of a first vehicle on which a third coating film is to be newly formed after a second coating film formed on a first coating film is peeled from a vehicle body; and
calculating a wage for operation of forming the third coating film for the first vehicle based on a period elapsed since peeling of the second coating film.

12. The information processing method according to claim 11, wherein the second coating film and the third coating film are later peelable coating films.

13. The information processing method according to claim 12, further comprising acquiring, for the first vehicle, data indicating a history of operation for the later peelable coating films.

14. The information processing method according to claim 12, further comprising acquiring, for the first vehicle, data indicating a date when the second coating film was peeled.

15. The information processing method according to claim 11, wherein the wage is calculated lower in a case where the period elapsed is shorter in comparison with a case where the period elapsed is long.

16. The information processing method according to claim 11, wherein, in a case where the period elapsed is less than a predetermined value, the wage is calculated lower than that in a case where the period elapsed is more than the predetermined value.

17. The information processing method according to claim 16, wherein, in the case where the period elapsed is less than the predetermined value, the wage obtained by subtracting an amount of money corresponding to cleaning operation for the vehicle body is calculated.

18. The information processing method according to claim 16, wherein, in the case where the period elapsed is less than the predetermined value, the wage is calculated obtained by subtracting an amount of money corresponding to cleaning operation for a part where an area where the second coating film is peeled and an area where the third coating film is to be formed overlap.

19. The information processing method according to claim 16, wherein, in the case where the period elapsed is more than the predetermined value, the wage is calculated obtained by adding an amount of money corresponding to cleaning operation for the vehicle body.

20. The information processing method according to claim 19, wherein the amount of money to be added is determined based on an application area of the third coating film.
